(19) United States
(12) Patent Application Publication
(10) Pub. No.: US 2026/0202031 A1
(43) Pub. Date: Jul. 16, 2026

(54) OPTICAL DEVICE AND VEHICLE EQUIPPED WITH THE SAME

(71) Applicant: HYUNDAI MOBIS CO., LTD., Seoul (KR)

(72) Inventors: Eun Bi KWON, Yongin-Si (KR); Seok Ho JEONG, Yongin-Si (KR)

(73) Assignee: HYUNDAI MOBIS CO., LTD., Seoul (KR)

(21) Appl. No.: 19/387,765

(22) Filed: Nov. 13, 2025

(30) Foreign Application Priority Data
Jan. 10, 2025 (KR) 10-2025-0003915

(51) Int. Cl. F21S 41/33; F21S 41/148; F21S 41/255; F21S 41/32; F21S 41/37; F21Y 101/00; F21Y 115/10

(52) U.S. Cl. CPC F21S 41/331; F21S 41/148; F21S 41/255; F21S 41/322; F21S 41/337; F21S 41/37; F21Y 2101/00; F21Y 2115/10

(57) ABSTRACT

Described is an optical device including: a printed circuit board; an LED mounted on the printed circuit board; a light guide layer that embeds the LED therein and includes a reflective surface and an exit surface; and a reflective pattern layer formed on the reflective surface of the light guide layer, wherein the reflective surface of the light guide layer includes a curved shape such that light of the LED is entirely internally reflected using the reflective pattern layer and emitted from the exit surface. The optical device implements a stereoscopic light emitting image using the light guide layer including the curved reflective surface that entirely internally reflects LED light in a lamp structure of a vehicle.

### CROSS-REFERENCE TO RELATED APPLICATIONS

This application claims the benefit of Korean Patent Application No. 10-2025-0003915, filed on Jan. 10, 2025, which is hereby incorporated by reference as if fully set forth herein.

### TECHNICAL FIELD

The present disclosure relates to an optical device and a vehicle equipped with the same that implement a stereoscopic light emitting image using a light guide layer including a curved reflective surface that entirely internally reflects LED light in a lamp structure of the vehicle.

### BACKGROUND

In general, a vehicle is equipped with various lamps for irradiating light frontwards depending on an external environment and time to secure a driver's field of view and to inform another vehicle of a travel path.

Such lamps are classified based on a purpose of use, and include a headlamp for illuminating a road ahead, a turn signal lamp for securing the driver's field of view and informing a location of the vehicle, a fog lamp for securing the driver's field of view and informing the location of the vehicle in addition to the headlamp in case of fog or rain, a reversing lamp that is turned on when the vehicle moves backwards, a brake lamp that is turned on when the driver operates a brake, and the like.

Halogen bulbs have been mainly used for the existing vehicle lamps. When a halogen lamp is used as a light source, a reflective plate that reflects light irradiated from the halogen lamp is present, and reflected light is irradiated frontwards using the reflective plate. However, the halogen lamp has an advantage of being inexpensive, but has disadvantages in that heat is severe during use, luminance is low compared to an amount of electricity used, and a lifespan is short.

In order to solve such problems, a vehicle lamp using a light-emitting diode (LED) has emerged. The LED lamp has advantages of high luminance, a long lifespan, and being operated with low power.

As described above, in order to implement various functions of the vehicle lamp, the LED is disposed to irradiate light. Generally, a stereoscopic structure such as a light guide, or multiple reflective plates are disposed to reflect light, thereby forming various types of light emitting images.

However, discoloration, deformation, and the like of the light guide resulted from continuous operation of the vehicle may occur, so that problems often occur in terms of maintenance. In addition, when the multiple reflective plates are disposed, a sense of disconnection of the light emitting image may occur because of an interface between the reflective plates, and a problem may occur also in sharpness.

Accordingly, there is a need for a means for more efficiently implementing the various types of light emitting images while solving the above-described problems.

### SUMMARY

The present disclosure provides an optical device and a vehicle equipped with the same, and more specifically, is intended to provide an optical device and a vehicle equipped with the same that implement a stereoscopic light emitting image using a light guide layer including a curved reflective surface that totally internally reflects LED light in a lamp structure of the vehicle.

In addition, the present disclosure is intended to provide an optical device and a vehicle equipped with the same that may implement a stereoscopic light emitting image without a sense of disconnection using a curved reflective surface.

In addition, the present disclosure is intended to provide an optical device and a vehicle equipped with the same that may secure uniformity of light emitted to an exit surface by defining a light path using a reflective pattern layer formed on a curved reflective surface.

Technical purposes to be achieved by the present disclosure are not limited to the technical purposes mentioned above, and other technical purposes not mentioned will be clearly understood by those skilled in the art to which the present disclosure pertains from the following description.

Provided is an optical device including: a printed circuit board; an LED mounted on the printed circuit board; a light guide layer that embeds the LED therein and includes a reflective surface and an exit surface; and a reflective pattern layer formed on the reflective surface of the light guide layer, wherein the reflective surface of the light guide layer includes a curved shape such that light of the LED is totally internally reflected using the reflective pattern layer and emitted from the exit surface.

The reflective pattern layer may include a plurality of facets arranged in a lattice shape.

The reflective surface of the light guide layer may be formed with a constant curvature.

The reflective surface of the light guide layer may have a curvature of one side thereof adjacent to the printed circuit board and a curvature of a remaining side thereof adjacent to the exit surface different from each other.

The reflective pattern layer may be formed in a shape corresponding to the curved shape of the reflective surface of the light guide layer.

The light guide layer may include a first optical resin for diffusing the light of the LED.

The exit surface of the light guide layer may include a second optical resin for reflecting or shielding a portion of the totally internally reflected light.

The exit surface of the light guide layer may have a convex curved shape such that the totally internally reflected light is refracted and emitted.

The optical device may further include a light emitting lens that is disposed in parallel with the exit surface of the light guide layer and forms a stereoscopic light emitting image using light emitted from the exit surface.

Provided is a vehicle including: a vehicle body; a lamp structure located in at least one of a front surface and a rear surface of the vehicle body; and an optical device embedded in the lamp structure, wherein the optical device includes: a printed circuit board; an LED mounted on the printed circuit board; a light guide layer that embeds the LED therein and includes a reflective surface and an exit surface; and a reflective pattern layer formed on the reflective surface of the light guide layer, wherein the reflective surface of the light guide layer includes a curved shape such that light of the LED is totally internally reflected using the reflective pattern layer and emitted from the exit surface.

The optical device and the vehicle equipped with the same according to the present disclosure may implement the stereoscopic light emitting image using the light guide layer including the curved reflective surface that totally internally reflects LED light in the lamp structure of the vehicle.

In addition, the optical device and the vehicle equipped with the same according to the present disclosure may implement the stereoscopic light emitting image without the sense of disconnection using the curved reflective surface.

In addition, the optical device and the vehicle equipped with the same according to the present disclosure may secure the uniformity of light emitted to the exit surface by defining the light path using the reflective pattern layer formed on the curved reflective surface.

Effects obtainable in the present disclosure are not limited to the effects mentioned above, and other effects not mentioned may be clearly understood by those skilled in the art to which the present disclosure pertains from the following description.

### BRIEF DESCRIPTION OF THE DRAWINGS

FIG. 1 is a diagram illustrating an optical device according to an embodiment of the present disclosure.

FIG. 2 is a diagram illustrating a plurality of facets formed in a reflective pattern layer in the optical device according to an embodiment of the present disclosure.

FIG. 3 is a diagram illustrating another embodiment of a light guide layer in the optical device of the present disclosure.

FIG. 4 is a diagram illustrating a shape of an exit surface of the light guide layer in the optical device according to an embodiment of the present disclosure.

### DETAILED DESCRIPTION

The following description sets forth exemplary embodiments of the invention with reference to the accompanying drawings. In the drawings, identical or similar elements are denoted by the same reference numerals regardless of figure number, and redundant descriptions thereof are omitted for clarity. The suffixes “module” and “unit,” as used for elements herein, are employed interchangeably for convenience and do not denote distinct meanings or functions. In describing the embodiments disclosed herein, detailed descriptions of well-known technologies may be omitted when such details could obscure the essence of the invention. The accompanying drawings are provided to facilitate understanding of the disclosed embodiments and are not intended to limit the technical scope of the invention. It should be understood that various modifications, equivalents, and alternatives fall within the spirit and scope of the invention as defined by the appended claims.

Terms including ordinal numbers such as “first,” “second,” and the like may be used to describe various elements, but such terms do not limit the elements. They are used solely for distinguishing one element from another.

When an element is described as being “connected to” or “coupled to” another element, it should be understood that the element may be directly connected or coupled, or indirectly connected or coupled through one or more intermediate elements. Conversely, when an element is described as being “directly connected to” or “directly coupled to” another element, it should be understood that no intermediate elements are present.

Unless expressly stated otherwise, the singular forms used herein include the plural forms as well.

As used herein, the terms “comprise,” “include,” and “have” (and variations thereof) specify the presence of stated features, integers, steps, operations, elements, components, or combinations thereof, but do not preclude the presence or addition of one or more other features, integers, steps, operations, elements, components, or combinations thereof.

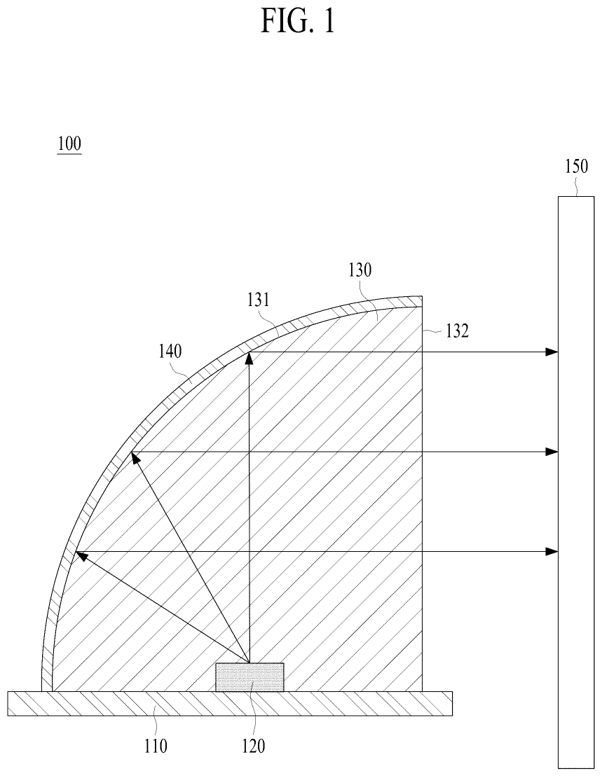

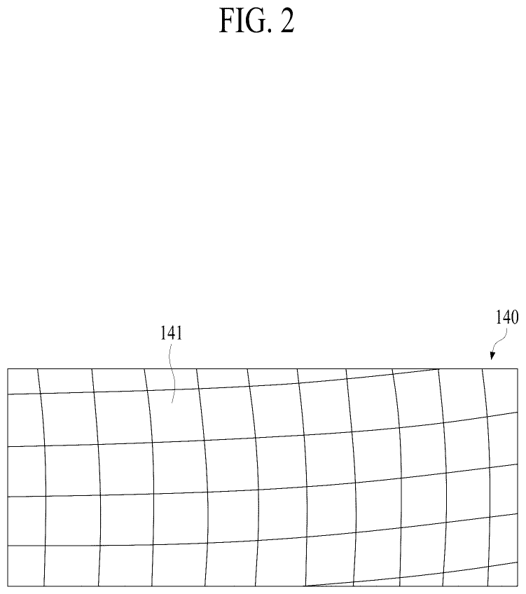

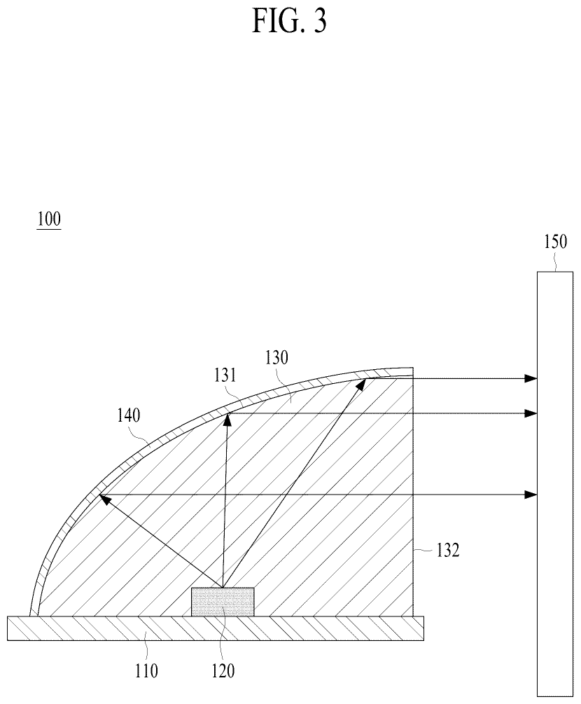

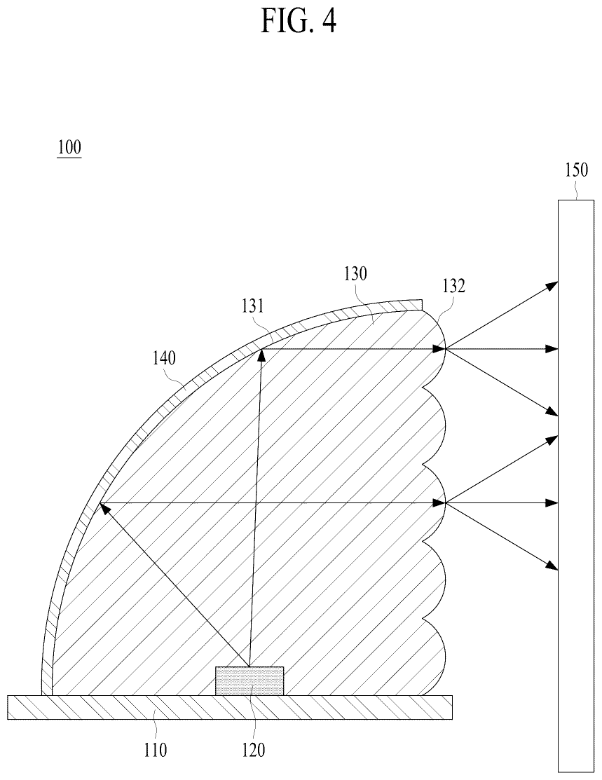

FIG. 1 is a diagram illustrating an optical device 100 according to an embodiment of the present disclosure. FIG. 2 is a diagram illustrating a plurality of facets 141 formed in a reflective pattern layer 140 in the optical device 100 according to an embodiment of the present disclosure. FIG. 3 is a diagram illustrating another embodiment of a light guide layer 130 in the optical device 100 of the present disclosure. Further, FIG. 4 is a diagram illustrating a shape of an exit surface 132 of the light guide layer 130 in the optical device 100 according to an embodiment of the present disclosure.

As illustrated in FIG. 1, the optical device 100 according to an embodiment of the present disclosure may include a printed circuit board (PCB) 110, a light-emitting diode (LED) 120, the light guide layer 130 including a reflective surface 131 and the exit surface 132, and the reflective pattern layer 140. In addition, a light emitting lens 150 that is disposed in parallel with the exit surface 132 of the light guide layer 130 and forms a stereoscopic light emitting image may be included. In addition, the optical device 100 according to an embodiment of the present disclosure may be embedded in a lamp structure located in at least one of a front surface and a rear surface of a vehicle body in the vehicle.

More specifically, the LED 120 may be mounted on the PCB 110 and may serve to output light. In addition, the PCB 110 may supply a current to the LED 120, so that the LED 120 may be turned on and light may be output. Here, the LED 120 of the optical device 100 according to an embodiment of the present disclosure may include a top-emission type and a side-emission type. In addition, the LED 120 may include a top and side-emission type.

The light guide layer 130 may be laminated on the PCB 110 to embed the LED 120 therein. Further, the light guide layer 130 may include a first optical resin for diffusing light of the LED 120. Here, the first optical resin may have a transparent color to increase the diffusion effect of light.

The first optical resin may be formed to include at least one of polymethyl methacrylate (PMMA), titanium dioxide (TiO2), silicon dioxide (SiO2), and aluminum oxide (AI2O3).

The light guide layer 130 may include the reflective surface 131 and the exit surface 132, and the reflective pattern layer 140 may be formed on the reflective surface 131 of the light guide layer 130. In particular, in the optical device 100 according to an embodiment of the present disclosure, the reflective surface 131 of the light guide layer 130 may have a curved shape such that light of the LED 120 is entirely (or totally) internally reflected using the reflective pattern layer 140 and is emitted from the exit surface 132.

As described above, in the related art, various types of light emitting images were implemented by disposing a stereoscopic structure such as a light guide, or multiple reflective plates to reflect light. However, discoloration, deformation, and the like of the light guide resulted from continuous operation of the vehicle may occur, so that problems often occur in terms of maintenance. In addition, when the multiple reflective plates are disposed, a sense of disconnection of the light emitting image may occur because of an interface between the reflective plates, and a problem may occur also in sharpness.

Accordingly, the optical device 100 according to an embodiment of the present disclosure is intended to solve the above-described problems by implementing the stereoscopic light emitting image while omitting the stereoscopic structure such as the light guide, or the multiple reflective plates in the past.

That is, the optical device 100 according to an embodiment of the present disclosure may implement the stereoscopic light emitting image, which is implemented by the light emitting lens 150, without the sense of disconnection using the curved reflective surface 131. In addition, uniformity of light emitted to the exit surface 132 may be secured by defining a light path using the reflective pattern layer 140 formed on the curved reflective surface 131. More details thereof will be described later.

Referring to FIG. 2 together, in the optical device 100 according to an embodiment of the present disclosure, the reflective pattern layer 140 may include the plurality of facets 141 arranged in a lattice shape. Here, the plurality of facets 141 may be formed in an mm-unit size, so that light of the LED 120 may be refracted and reflected at various angles. Further, accordingly, various light paths may be defined and the uniformity of light emitted to the exit surface 132 may be secured.

In addition, the optical device 100 according to an embodiment of the present disclosure may process the reflective surface 131 of the light guide layer 130 such that the plurality of facets 141 described above are formed therein. In addition, light of the LED 120 may be refracted at various angles using the reflective surface 131 of the light guide layer 130 where the plurality of facets 141 are formed.

That is, in the optical device 100 according to an embodiment of the present disclosure, light of the LED 120 is refracted and reflected at the various angles using the plurality of facets 141 formed in the reflective pattern layer 140 or the reflective surface 131 of the light guide layer 130, thereby defining the various light paths and securing the uniformity of light emitted to the exit surface 132.

In addition, referring to FIGS. 1 and 3 together, in the optical device 100 according to an embodiment of the present disclosure, the reflective surface 131 of the light guide layer 130 on which the reflective pattern layer 140 is formed may be formed with a constant curvature. In addition, the reflective surface 131 of the light guide layer 130 may have a curvature of one side thereof adjacent to the PCB 110 and a curvature of a remaining side thereof adjacent to the exit surface 132 that are different from each other.

That is, the optical device 100 according to an embodiment of the present disclosure may variously configure the curvature of the reflective surface 131 on which the reflective pattern layer 140 is formed, so that light of the LED 120 may be reflected at the various angles. Further, accordingly, the various light paths may be defined to secure the uniformity of light emitted to the exit surface 132.

In this regard, the reflective pattern layer 140 formed on the reflective surface 131 of the light guide layer 130 may be formed in a shape corresponding to the curved shape of the reflective surface 131. By forming the reflective pattern layer 140 serving to entirely reflect light of the LED 120 internally of the light guide layer 130 to have the shape corresponding to the curved shape of the reflective surface 131, the stereoscopic light emitting image implemented by the light emitting lens 150 may be implemented without the sense of disconnection.

Additionally, in the optical device 100 according to an embodiment of the present disclosure, the exit surface 132 of the light guide layer 130 may include a second optical resin that reflects or shields a portion of the entirely internally reflected light. For example, the second optical resin may have at least one of a black color and a chromatic color.

Further, the second optical resin may be formed to include at least one of polymethyl methacrylate (PMMA), titanium dioxide (TiO2), silicon dioxide (SiO2), and aluminum oxide (AI2O3).

In this regard, the second optical resin may be formed at a mixing ratio different from that of the above-described first optical resin. For example, the second optical resin may be formed to have a reflectance higher than that of the first optical resin by adjusting the mixing ratio of the above-described materials.

Furthermore, the second optical resin may be formed on the exit surface 132 of the light guide layer 130. That is, the second optical resin may be applied to the exit surface 132 of the light guide layer 130. In addition, the optical device 100 according to an embodiment of the present disclosure may form the various stereoscopic light emitting images by adjusting an amount of light emitted from the exit surface 132 of the light guide layer 130 using the second optical resin.

In addition, referring to FIG. 4, in the optical device 100 according to an embodiment of the present disclosure, the exit surface 132 of the light guide layer 130 may have a convex curved shape such that the entirely internally reflected light is refracted and emitted. In addition, a plurality of convex curved shapes may be formed at the exit surface 132 of the light guide layer 130. Additionally, the plurality of curved surfaces formed at the exit surface 132 may be formed to have different curvatures.

Further, accordingly, the optical device 100 according to an embodiment of the present disclosure may allow the entirely internally reflected light to be diffused and emitted at the various angles from the exit surface 132.

Accordingly, the optical device 100 according to an embodiment of the present disclosure may define the various light paths and allow the various stereoscopic light emitting images to be formed in the light emitting lens 150, using the shape of the exit surface 132 of the light guide layer 130. In addition, using light diffused at the various angles from the exit surface 132 of the light guide layer 130, the stereoscopic light emitting image implemented in the light emitting lens 150 may be implemented without the sense of disconnection.

In summary, the optical device and the vehicle equipped with the same according to the present disclosure may implement the stereoscopic light emitting image using the light guide layer including the curved reflective surface that the entirely internally reflects LED light in the lamp structure of the vehicle. In addition, the stereoscopic light emitting image may be implemented without the sense of disconnection using the curved reflective surface. In addition, the uniformity of light emitted to the exit surface may be secured by defining the light path using the reflective pattern layer formed on the curved reflective surface.

The foregoing detailed description is not to be construed in a limiting sense but is to be considered as illustrative. The scope of the present invention should be defined by the reasonable interpretation of the appended claims, and all modifications, equivalents, and alternatives falling within the equivalent scope of the invention are intended to be included therein.

What is claimed is:

1. An optical device comprising:
a printed circuit board (PCB);
a light-emitting diode (LED) mounted on the PCB;
a light guide layer embedding the LED therein and including a reflective surface and an exit surface; and
a reflective pattern layer disposed on the reflective surface of the light guide layer,
wherein the reflective surface of the light guide layer has a curved shape such that light of the LED is entirely internally reflected using the reflective pattern layer and emitted from the exit surface.

2. The optical device of claim 1, wherein the reflective pattern layer includes a plurality of facets arranged in a lattice shape.

3. The optical device of claim 1, wherein the reflective surface of the light guide layer has a constant curvature.

4. The optical device of claim 1, wherein the reflective surface of the light guide layer has:
a first side portion adjacent to the PCB and having a first curvature; and
a second side portion adjacent to the exit surface and having a second curvature different from the first curvature.

5. The optical device of claim 1, wherein the reflective pattern layer has a shape corresponding to the curved shape of the reflective surface of the light guide layer.

6. The optical device of claim 1, wherein the light guide layer includes a first optical resin configured to diffuse the light of the LED.

7. The optical device of claim 6, wherein the exit surface of the light guide layer includes a second optical resin configured to reflect or shield a portion of the entirely internally reflected light.

8. The optical device of claim 1, wherein the exit surface of the light guide layer has a convex curved shape such that the entirely internally reflected light is refracted and emitted.

9. The optical device of claim 1, further comprising a light emitting lens disposed in parallel with the exit surface of the light guide layer and configured to form a stereoscopic light emitting image using the light emitted from the exit surface.

10. A vehicle comprising:
a vehicle body;
a lamp structure disposed in at least one of a front surface and a rear surface of the vehicle body; and
an optical device embedded in the lamp structure,
wherein the optical device includes:
a printed circuit board (PCB);
a light-emitting diode (LED) mounted on the PCB;
a light guide layer configured to embed the LED therein and including a reflective surface and an exit surface; and
a reflective pattern layer disposed on the reflective surface of the light guide layer, and
wherein the reflective surface of the light guide layer has a curved shape such that light of the LED is entirely reflected internally using the reflective pattern layer and emitted from the exit surface.
